(19) United States
(12) Patent Application Publication
(10) Pub. No.: US 2014/0088759 A1
(43) Pub. Date: Mar. 27, 2014

(54) METHOD AND TOOL FOR GIVING OUT INFORMATION IN A CONTAINER FLOW SYSTEM

(71) Applicant: Krones AG, Neutraubling (DE)

(72) Inventor: Wolfgang Hahn, Neutraubling (DE)

(73) Assignee: Krones AG, Neutraubling (DE)

(21) Appl. No.: 14/118,780

(22) PCT Filed: May 3, 2012
(86) PCT No.: PCT/EP2012/058127

§ 371 Date: Nov. 19, 2013

(30) Foreign Application Priority Data
May 30, 2011 (DE) DE102011050715.9

(51) Int. Cl. B65G 43/08; B65G 21/20

(52) U.S. Cl. CPC B65G 43/08; B65G 21/20
USPC 700/230

(57) ABSTRACT

A method and a tool for information output. The method involves determining and/or assessing one or more physical parameters of one or more components in a system or apparatus. Also included is a first assigner which associates a first is-information or a first is-not-information, respectively, to several parameters, which first is- or is-not-information is output and/or displayed depending on the determined and/or assessed parameters. Further included is a second assigner, which associates a second is-information or a second is-not-information, respectively, to several of the determined and/or assessed parameters, which second is- or is-not-information is output and/or displayed depending on the determined and/or assessed parameters in addition to, or in place of, the first is- or is-not-information. The system is a container flow system in which containers are directed and/or guided between the at least two components in a predetermined transport direction and/or along a predetermined transport path.

The present invention relates to a method and a tool for information output.

### BACKGROUND

The prior art already shows tools for determining measurement values. The patent application publication CH 424 486 A refers to an adjustment and measuring gauge for adjusting the settings of woodworking machines. The measuring gauge comprises a slider, which is arranged in the area of a measuring stick scale for displaying readings. DE 93 01 968 U1 also discloses such a tool, which includes a tong-like means for gripping a workpiece and which has a measuring scale at the opposite end. These adjustment gauges known from prior art require the user to ascertain whether a measurement reading resulting from a performed measurement process is within the range of nominal values or whether the result of the measurement deviates from the nominal values. The assignment of measurement values to predefined nominal values by a user is prone to errors, as nominal values may change with regard to different work and adjustment processes.

### SUMMARY OF THE INVENTION

Not only for measurement processes, but also for a large number of further work and adjustment processes, would methods and tools be desirable which present their results in a simple manner after taking measurements of parameters. It is desirable to do away as far as possible with the laborious and error-prone manual assignment of measurement values to information. Adjusting the settings of an apparatus and adapting a system to a later work process or to a product in particular require that conclusions are drawn about which setting adjustments to the apparatus or to the system are necessary or unnecessary. For inexperienced employees or employees being trained it would also be desirable to have a method and a tool which provides direct information or which indicates necessary settings or adjustments in addition to or in the place of providing merely measurement values. Furthermore, it may be in the interest of the users, and also useful in order to prevent errors while making settings, to be able to draw conclusions about necessary adjustments or settings from a performed measurement process without having to know the nominal measurement values.

It is an object of the present invention to provide a method and a tool which make further information accessible without requiring users to assign parameters to predefined nominal values, and in particular to provide further information regarding the necessity or nonnecessity of adjusting the settings of an apparatus or a system. The method and the tool are furthermore intended to facilitate making adjustments to the settings of a system. They are also intended to reduce or prevent errors in adjusting the settings.

The invention provides that the method and the tool are intended for information output. The information output may be performed acoustically, for instance, but in a preferred exemplary embodiment of the present invention it is performed visually. In a first process step, one or more components in a system and/or one or more physical parameters of one or more components of an apparatus are determined and/or assessed. The apparatus may be a work machine or a work device, for instance. The components may be individual parts, for instance, of the work machine or of the work device, such as may support the function of said work machine or work device. The present invention is, however, not limited to such work machines or work devices, and the method and the tool may therefore be applied in a multitude of other apparatuses and systems.

A measuring apparatus and/or a measuring unit, for instance, may be used for determining and/or assessing one or more physical parameters. The physical parameters may be identified, for instance, as pressure and/or as force and/or as lengths or distances and/or as other physical parameters. According to the parameter that is supposed to be assessed or determined, the measuring device and/or the measuring unit may also comprise diverse measuring instruments. The measuring device and/or the measuring unit may, for instance, comprise one or more sensors for capturing physical parameters. Pressure sensors and/or tactile sensors and/or optical sensors and/or acoustic sensors may be part of a tool according to the invention, or they may contribute to performing the method according to the invention in a large variety of embodiments.

Further included is a first assignment means which associates a first is-information or a first is-not-information, respectively, to several parameters, which is- or is-not-information is displayed and/or output depending on the assessed parameters. In particular, there are at least two parameters to which a first is-information or a first is-not-information is associated. The assignment of the respective parameters to a first is- or is-not-information may be performed, for instance, by a computer-aided system. Is-information or is-not-information, in a preferred embodiment variant of the present invention, is absolute information, which may inform a user whether one or more components of the system or the apparatus fall within nominal conditions or whether they deviate from nominal conditions.

Additionally included is a second assignment means, which associates a second is-information or a second is-not-information, respectively, to several of the determined and/or assessed parameters, which is- or is-not-information is output and/or displayed depending on the determined and/or assessed parameters in addition to, or in place of, the first is- or is-not-information.

The system according to the invention is a container flow system. The container flow system may comprise, for instance, a conveying device, preferably a horizontal conveying device and/or other means for conveying containers along a transport path. The containers are guided and/or directed between at least two components in a predetermined transport direction and/or along a predetermined transport path. It is therefore possible for one or more of the components to be designed as guide plates and/or guide bars and/or guide walls. The first and/or the second is-not-information may therefore indicate no necessary adjustment of at least one component for directing and guiding containers between two components. The nominal arrangement and/or the nominal alignment of the components may be defined such that the containers keep a defined distance to those components between which the containers are being guided and/or directed in the predetermined transport direction and/or along the predetermined transport path. The distance may be defined such that the containers can be directed in an optimal manner without being jammed. It is therefore possible to output the is-information or the second is-information in the instance of the relative distance of two of the components deviating from a predefined range. If the relative distance between the components is too large and/or too small, it is intended that the is-information and/or the second is-information is output and/or displayed. The first is-information and the first is-not-information may inform a user about the necessity or non-necessity of readjusting one or more components of the system in order to establish a nominal alignment in a first section, while the second is-information and the second is-not-information may inform a user about the necessity or non-necessity of readjusting one or more components of the system in order to establish a nominal alignment in a further section. The first assignment means and/or the second assignment means may accordingly take into account the container geometry and in particular the maximum container diameter.

It is conceivable to include the possibility of selecting between the output of the first is- or is-not-information and the output of the second is- or is-not-information. It may be provided, for instance, that a physical parameter is assessed and that a first is- or is-not-information is output and/or displayed and a second is- or is-not-information is output and/or displayed in dependence on the assessed parameter. The output or display may be performed, for instance, by acoustic signals and/or in a visual manner. This may be effected, for instance, by using a colored display (green=is-information; red=is-not-information) or by using digits (0=is-information or readjusting is not necessary; 1=is-not-information) or by using other suitable signals. Further possibilities for indicating an is-information and/or an is-not-information by means of visual signals are known to those skilled in the art. It is therefore not necessary to explicitly cite these possibilities. Furthermore, a display unit or a display or the like may be provided, which is intended for outputting or displaying the respective is- or is-not-information. It is further conceivable that the first is- or is-not-information is output and/or displayed simultaneously with the second is- or is-not-information. The output or display may be performed analogously, preferably, however, the output or display is performed in a digital manner.

In a preferred embodiment of the present invention, the method for information output is provided by means of the alignment and/or the arrangement of one or more readjustable and/or resettable components in a system or in an apparatus. It is thereby possible for the determined and/or assessed physical parameters to refer to the actual arrangement and/or to the actual alignment of one or more of the components. It is conceivable that the system according to the invention is defined in three-dimensional space, for instance. One embodiment of the present invention may comprise means for optical acquisition of the actual arrangement and/or the actual alignment of one or more components in the system. Camera systems and optical sensors are suitable examples for performing the method. The parameters may be determined and/or assessed by data on the alignment and/or arrangement of one or more components in three-dimensional space, for instance. These components may accordingly possess an actual arrangement and/or an actual alignment in three-dimensional space. Furthermore, the parameters may may be formed as distance parameters that refer to the relative distance of one or more components of the apparatus or the system. It may also be provided that several determining and/or assessment processes are performed and that for each determining and/or assessment process either the first is-information or the second is-information indicates a necessary readjustment and/or resetting of one or more components in the system or in the apparatus in order to establish a nominal alignment. Each determining and/or assessment process may be performed at a certain position of one or more components in a system and/or one or more components in an apparatus. Two or more determining and/or assessment processes may be performed one after the other, for instance. Furthermore, it may be provided that for each determining and/or assessment process either the first is-not-information or the second is-not-information indicates no necessary readjustment and/or resetting of one or more components in the system or in the apparatus in order to establish a nominal alignment. Furthermore, it may be provided that the first is-information or the second is-information indicates a necessary readjustment and/or resetting of one or more components in the system in order to establish a nominal alignment.

The parameters may be defined, for instance, by data on the relative distance of two or more components to each other. In a preferred embodiment of the present invention, the relative actual distance and/or the relative actual alignment of each of at least two components to each other is determined and/or assessed. Preferably, the process of determining and/or assessing is performed by mechanical means, which at least in parts have a surface contact with at least one of the components during the determining and/or assessment process of the respective parameters or of the relative distance. A tool as described in detail in the following may in particular be provided as such a mechanical means.

The invention further relates to a tool for information output which may comprise a base body and a measuring unit for determining and/or assessing one or more physical parameters of one or more components of a system and/or of an apparatus. Furthermore, the tool may comprise a first assignment means for assigning several parameters to a first is- or to a first is-not-information, respectively, wherein the first is- or the first is-not-information can be output and/or displayed by the tool depending on the determined and/or assessed parameters. The output and/or display may be effected by the tool in a visual or acoustical manner, for instance. The tool according to the invention also comprises a second assignment means for assigning several parameters to a second is- or to a second is-not-information, respectively, wherein the second is- or the second is-not-information can be output and/or displayed by the tool depending on the determined and/or assessed parameters.

According to the invention, the tool is used for systems in which the first component and the second component are designed as readjustable guide bars and/or readjustable guide elements for guiding and/or directing containers on a conveyor. The readjustment may thereby be defined as a readjustment of the relative distance of the guide bars and/or guide elements to each other. The conveyor may be designed as a horizontal conveying device, for instance.

If the base body has a suitable geometric design, it is furthermore possible to verify and, if required, set and/or adjust the height or the distance of the first component and the second component in relation to a bottom surface, for instance a conveyor, and preferably a horizontal conveyor. The first and the second component can thereby abut on one of sides of the base body facing the first and the second component. The base body may accordingly comprise two parallel or at least nearly parallel stop surfaces for one component each of the apparatus or of the system.

In a preferred embodiment of the present invention, the base body of the tool comprises a first arm section, which is brought into a surface contact with a first component, and a second arm section with a measuring unit, which is brought into a surface contact with a second component, for instance by means of a plug gauge, for determining and/or assessing parameters about the relative actual distance of the first component to a second component. The tool may also comprise means for the digital display of the is- and/or of the is-not-information. The means for the digital display are thereby preferably arranged on the tool.

The measuring unit may furthermore comprise an indicator and/or an indicator may be arranged on the measuring unit. When the measuring unit and/or parts of the measuring unit are shifted, the indicator comes to present and/or display the respective is- and/or is-not-information. The indicator may be arranged on a plug gauge or it may be part of a plug gauge, for instance. The indicator may also point at the respective is- and/or the respective is-not-information, for instance. It may also be provided that the is-information and the is-not-information are visibly applied onto the tool and that the indicator comes to point at the respective information when the stop element is shifted. The indicator moves, for instance, together with the measuring unit when the measuring unit is shifted and/or together with parts of the measuring unit when these are shifted. In a further embodiment, the indicator may be designed as a digital part of the measuring unit. The is-information and the is-not information may be indicated, for instance, by different colors, for example by green and red, with the colors being visibly applied onto the tool. The indicator may be guided in a receiving slot so that the measuring unit is limited in its shifting range. If a digital indicator is used, it is possible for the indicator to point at the respective information when the measuring unit is shifted.

The first arm section may be arranged between the two components while assessing and/or determining the physical parameters. It is also possible that, while assessing and/or determining the physical parameters, the measuring unit and/or parts of the measuring unit are brought into surface contact with one of the outer sides of the second component, which outer side of the second component is averted from the first component. If the first arm section is located between the two components, it may also be provided that said first arm section or parts of said first arm section abut on the first component during the process of assessing and/or determining the physical parameters.

For easier handling, the base body of the tool may comprise a recess, which is designed as a handgrip and/or a handle. Handles and/or handgrip s may also be separate parts that are additionally arranged on the base body.

In summary, the advantages of the present invention lie in being able to prevent erroneous settings of guide rails or guide bars. Furthermore, the invention facilitates fast and precise adjustment setting. Dysfunctions during production start are also prevented, as are subsequent corrections of the rail setting. Other advantageous effects are the reduction of rejects and the improvement of the installation's efficiency.

### BRIEF DESCRIPTION OF THE DRAWINGS

In the following passages, the attached figures further illustrate exemplary embodiments of the invention and their advantages. The size ratios of the individual elements in the figures do not necessarily reflect the real size ratios. It is to be understood that in some instances various aspects of the invention may be shown exaggerated or enlarged to facilitate an understanding of the invention.

FIG. 1 shows a schematic view of an embodiment of a system in which the method according to the invention and the tool according to the invention may be employed.

FIG. 2 shows a further schematic view of an embodiment of a system in which the method according to the invention and the tool according to the invention may be employed.

FIG. 3 shows a schematic view of an embodiment of a tool according to the invention.

FIG. 4 shows a schematic view of an embodiment of a measuring unit such as may be part of a tool according to the invention.

### DETAILED DESCRIPTION

The same or equivalent elements of the invention are designated by identical reference characters. Furthermore and for the sake of clarity, only the reference characters relevant for describing the respective figure are provided. It should be understood that the detailed description and specific examples of the tool and the method according to the invention, while indicating preferred embodiments, are intended for purposes of illustration only and are not intended to limit the scope of the invention.

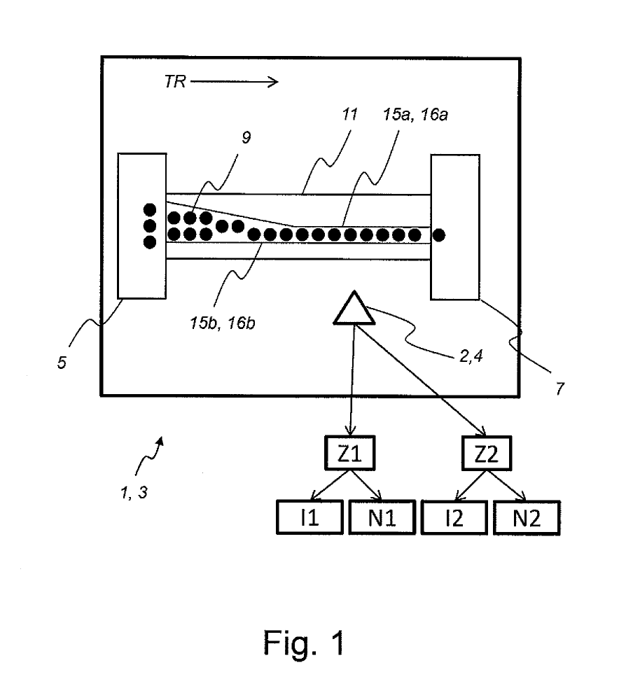

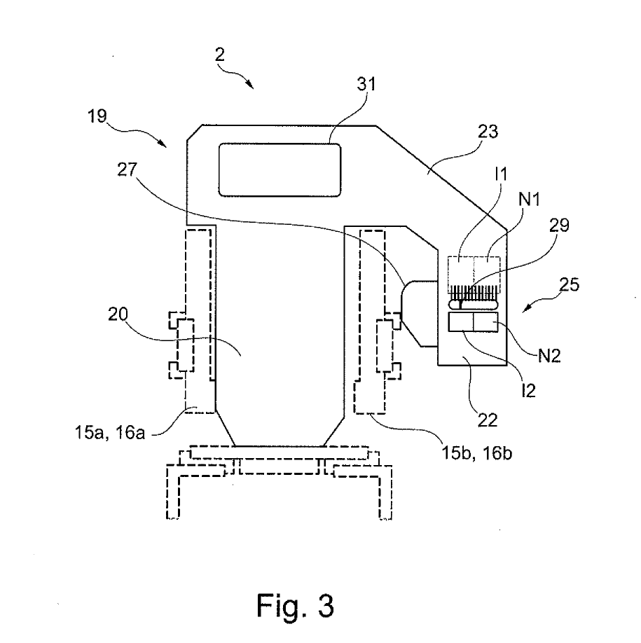

FIG. 1 shows a schematic view of an embodiment of a system 1 in which the method according to the invention and the tool 2 according to the invention may be employed. The system 1 as presented here is designed as a container flow system 3. In the system 1 or in the container flow system 3 are readjustable components 15a and 15b, which, in the present figure, are provided as guide bars 16a and 16b for guiding and directing the containers 9 on a horizontal conveying device 11. In the illustrated exemplary embodiment, the containers 9 are transported in the transport direction TR. The containers 9 are transferred from a first station 5 or processing device to a second station 7 or processing device by means of the guide bars 16a and 16b. In the illustrated exemplary embodiment, the containers 9 are initially in a disordered mass flow after being transferred to the horizontal conveying device 11. The guide bars 16a and 16b guide the containers 9 in such a manner that they form an organized, single-lane flow of containers before being transferred to the second station 7. In order to prevent the containers 9 from jamming, the guide bars 16a and 16b must possess a defined alignment or they must be located at a defined distance from each other, said distance being selected depending on the respective container geometry. Means for acquiring information 4 are provided for assessing the parameters on the alignment of the guide bars 16a and 16b or for assessing the parameters on the relative actual distance of the guide bars 16a and 16b to each other. The means for acquiring information 4 may be present as an optical acquisition system, for instance. In a preferred embodiment, however, it is provided as tool 2, which is illustrated in detail in FIG. 3, for instance. After assessing the parameters by employing the means for acquiring information 4 or by employing the tool 2, a first assignment means Z1 outputs a first is-information I1 or a first is-not-information N1, respectively, depending on the assessed parameters. A second assignment means Z2 then outputs a second is-information 12 or a second is-not-information N2. It may be provided, for instance, that the distance of the guide bars 16a and 16b to each other is selected to be different in a first section from the distance of the guide bars 16a and 16b to each other in a second section. For instance, the first section may be defined by the containers 9 being guided in a straight line, and the second section may be defined by the containers 9 being guided in a curved line (not illustrated here). According to the section where the parameters are assessed, the first is- and is-not-information I1 and N1 or the second is- and is-not-information I2 and N2 may inform a user about the necessity of adjusting the relative distance of the guide bars 16a and 16b to each other in the respective section. This is in particular necessary as the guide bars 16a and 16b need to be arranged at a greater relative distance to each other for guiding the containers 9 in a curved line than for guiding the containers 9 in a straight line. It is not possible to output the first is- or is-not-information I1 and N1 at the same time with the second is- and is-not-information I2 and N2. The output of the respective is- and is-not-information I1, N1, I2, and N2 may be presented on a display. The output or presentation of the is- and is-not-information I1, N1, I2, and N2 is preferably performed by means of a tool 2, which is described in detail in FIG. 3.

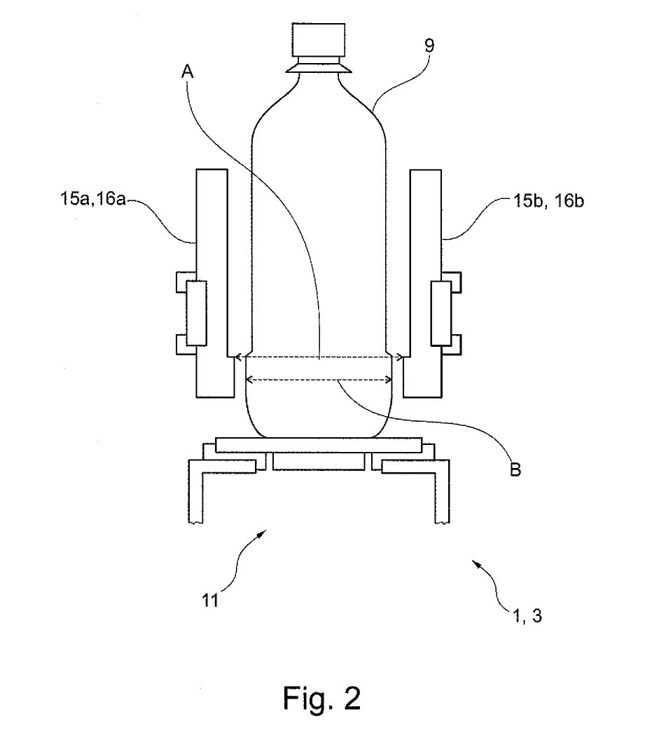

FIG. 2 shows a further schematic view of an embodiment of a system I in which the method according to the invention and the tool 2 (cf. FIG. 3) according to the invention may be employed. As in FIG. 1, the two components 15a and 15b are shown here, which are formed as guide bars 16a and 16b. The method according to the invention provides that the tool 2 according to the invention (cf. FIG. 3) is used for assessing the relative actual distance A of the guide bars 16a and 16b to each other. In order to guide containers 9 in an optimized manner, the results should be used to adjust the actual distance A to the nominal distance. The adjustment may be performed fully automated or manually, for instance. In practice, it has proven suitable to select the nominal distance based on the maximum diameter B of the containers 9 to be guided and to supplement this an additional distance between the container 9 and the guide bar 16a, 16b, wherein the additional distance between a container 9 and the guide bar 16a and 16b may preferably be between 3 mm and 6 mm. If the actual distance A corresponds to the nominal distance, an is-not-information N1 or N2 can be output. Accordingly, the relative distance A of the guide bars 16a and 16b to each other does not require resetting or adjusting in order to guide the containers 9 safely between the guide bars 16a and 16b. If the actual distance A does not correspond to the nominal distance, an is-information I1 or I2 can be output. It may be provided that a first nominal distance is defined by a first assignment means (cf FIG. 1). If the actual distance A corresponds to the first nominal distance, a first is-not-information N1 can be output. If the actual distance A does not correspond to the first nominal distance, a first is-information I1 can be output. Furthermore, a second nominal distance can be defined by a second assignment means (cf. FIG. 1). If the actual distance A corresponds to the second nominal distance, a second is-not-information N2 can be output. If the actual distance A does not correspond to the first nominal distance, a second is-information I2 can be output. The first nominal distance may be provided, for instance, for sections in which containers 9 are guided in a straight line or at least in an approximately straight line. The second nominal distance then may be provided for sections in which containers 9 are guided along curved lanes and/or in sections in which containers 9 are deflected. In practice, it is necessary that the nominal distance between the guide bars 16a and 16b is greater when guiding the containers 9 in a curved line than when guiding the containers 9 in a straight line.

FIG. 3 shows a schematic view of an embodiment of a tool 2 according to the invention. The tool 2 according to the invention has a base body 19 comprising a first arm section 20 and a second arm section 23. The tool 2 further comprises a measuring unit 25, which is provided for assessing the relative distance A (cf. FIG. 2) between two components 15a and 15b, which in FIG. 3 are formed as guide bars 16a and 16b. The relative distance is assessed by means of a plug gauge 27, which is shiftably mounted on the base body 19 and which comprises an indicator 29. The plug gauge 27 forms part of the measuring unit 25. The plug gauge 27 is in surface contact with the guide bar 16b during the process of assessing the distance A. The first arm section 20 is arranged between the guide bars 16a and 16b. After assessment of the relative distance A, the indicator serves for displaying a first is-information I1 or a first is-not-information N1 and a second is-information I2 or a second is-not-information N2. On assessing the actual distance A in the curvilinear section of the guide bars 16a and 16b, the first is-information I1 and the first is-not-information N1 provide information about whether the actual distance A corresponds to a predeined nominal distance. Furthermore, on assessing the actual distance A in the straight-lined section of the guide bars 16a and 16b, the second is-information I2 and the second is-not-information N2 provide information about whether the actual distance A corresponds to a predefined nominal distance. For easier handling of the tool 2, the base body 19 is additionally formed with a handgrip 31.

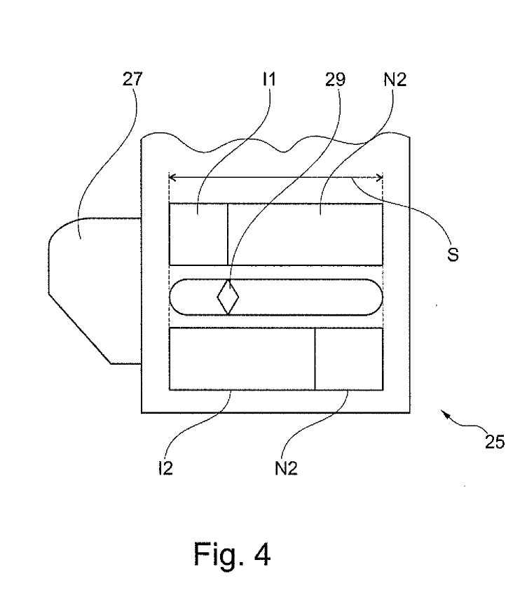

FIG. 4 shows a schematic view of an embodiment of a measuring unit 25 such as may be part of a tool 2 according to the invention. In one embodiment of the present invention, the indicator 29 of the measuring unit, when having surface contact with the second component 15 (cf FIG. 3), may move along a transport path S and thus point at the respective is-information I1 and I2 or at the respective is-not-information N1 and N2. In a preferred embodiment, the indicator 29 is designed to operate digitally. The process of pointing at the respective is-information I1 and I2 or at the respective is-not-information N1 and N2 is performed in analogy to the process for the mechanical embodiment variant.

The invention has been described with reference to a preferred embodiment. Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

List of Reference Characters
1 System
2 Tool
3 Container flow system
4 Means for acquiring information
5 First station
7 Second station
9 Container
11 Horizontal conveying device
15a Component
15b Component
16a Guide bar
16b Guide bar
19 Base body
20 First arm section
23 Second arm section
25 Measuring unit
27 Plug gauge
29 Indicator
31 Handgrip
A Actual distance
B Maximum container diameter
I1 First is-information
I2 Second is-information
N1 First is-not-information
N2 Second is-not-information
S Transport path
TR Transport direction
Z1 First assignment means
Z2 Second assignment means

1-15. (canceled)

16. A method for information output comprising:
determining or assessing one or more physical parameters of one or more components in a container flow system wherein containers are directed or guided between at least two of the components in a predetermined transport direction or along a predetermined transport path;
associating, via a first assigner, a first is-information or a first is-not-information, respectively, to several of the parameters, the first is- or is-not-information being output or displayed depending on the determined or assessed parameters; and
associating, via a second assigner, a second is-information or a second is-not-information, respectively, to several of the determined or assessed parameters, the second is- or is-not-information being output or displayed depending on the determined or assessed parameters in addition to, or in place of, the first is- or is-not-information.

17. The method as recited in claim 16 wherein the first is- or is-not-information is output or displayed simultaneously with the second is- or is-not-information.

18. The method as recited in claim 16 wherein the is-information and the is-not-information are digitally output.

19. The method as recited in claim 16 wherein the method is for outputting information about the alignment or arrangement of one or more readjustable or resettable components in the container flow system, wherein the determined or assessed physical parameters refer to the actual arrangement or to the actual alignment of one or more of the components, and wherein at least two determining or assessment steps are performed, and wherein for each determining or assessment step either the first is-information or the second is-information indicates a necessary readjustment or resetting of one or more of the components in the container flow system in order to establish a nominal alignment, and wherein for each determining or assessment step either the first is-not-information or the second is-not-information indicates no necessary readjustment or resetting of one or more of the components in the container system in order to establish the nominal alignment.

20. The method as recited in claim 19 wherein the parameters are defined by the relative actual distance between, in each case, the at least two components, and wherein the step of determining or assessing the respective parameters is performed by one or more mechanical devices, which at least in parts include a surface contact with at least one of the components during the determining or assessment process of the respective parameters.

21. The method as recited in claim 16 wherein the first assignment device or the second assignment device takes into account a container geometry.

22. The method as recited in claim 21 wherein the container geometry taken into account includes a maximum container diameter.

23. The method as recited in claim 16 wherein the at least two components guide containers in a straight line in a first section, and wherein the at least two components guide containers in a curved line in a second section, and wherein the first is-information indicates a necessary readjustment of one or more components in the first section and the first is-not-information indicates no necessary readjustment of one or more components in the first section, and wherein the second is-information indicates a necessary readjustment of one or more components in the second section, and wherein the second is-not-information indicates no necessary readjustment of one or more components in the second section.

24. The method as recited in claim 16 wherein the is-information or the is-not-information is output or displayed visually.

25. The method as recited in claim 24 wherein the is-information or the is-not information is displayed via different colors.

26. A tool for information output comprising:
a base body; and
a measuring unit for determining or assessing one or more physical parameters of one or more components, the components including a first component and a second component formed as readjustable guide bars or as readjustable guide elements for guiding or directing containers on a conveyor;
an assigner for assigning several parameters to a first is- or to a first is-not-information, respectively, wherein the first is- or the first is-not-information can be output and/or displayed by the tool depending on the determined and/or assessed parameters; and
a second assigner for assigning several parameters to a second is- or to a second is-not-information, respectively, wherein the second is- or the second is-not-information can be output and/or displayed by the tool depending on the determined and/or assessed parameters in addition to, or in place of, the first is- or is-not-information, characterized in that the first component and the second component are formed as readjustable guide bars and/or as readjustable guide elements for guiding and/or directing containers on a conveyor.

27. The tool as recited in claim 26 wherein the base body comprises a first arm section brought into surface contact with the first component, and a second arm section with a measuring unit brought into surface contact with the second component, and provided for determining or assessing parameters about a relative actual distance of the first component to the second component.

28. The tool as recited in claim 26 further comprising a display or indicator for digitally displaying or presenting the respective is-information and/or is-not-information.

29. The tool as recited in claim 27 wherein the measuring unit comprises an indicator or further comprising an indicator arranged on the measuring unit, and wherein the respective is-information or is-not-information is presentable or displayable via the indicator by shifting the measuring unit or parts of the measuring unit.

30. The tool as recited in claim 27 wherein the first arm section is arranged between the two components while assessing or determining the physical parameters and wherein the measuring unit or parts of the measuring unit are brought into surface contact with one of the outer sides of the second component, the one outer side being averted from the first component while assessing or determining the physical parameters.

31. The tool as recited in claim 26 wherein the base body comprises a recess formed as a handgrip or a handle.

32. The tool as recited in claim 26 wherein the is-information or the is-not-information can be output or displayed visually.

33. The tool as recited in claim 32 wherein the is-information or the is-not information can be displayed via different colors.
